(19) United States
(12) Patent Application Publication
(10) Pub. No.: US 2023/0342824 A1
(43) Pub. Date: Oct. 26, 2023

(54) System and Method for Delivering Customized Pricing of Streamed Video Content

(71) Applicant: VidaFair LLC, Austin, TX (US)

(72) Inventor: Robert Bowdon, Austin, TX (US)

(21) Appl. No.: 17/726,895

(22) Filed: Apr. 22, 2022

(51) Int. Cl. G06Q 30/02; G06Q 20/12; G06Q 20/06

(52) U.S. Cl. CPC G06Q 30/0283; G06Q 20/123; G06Q 20/065; G06Q 2220/12

(57) ABSTRACT

The current disclosure relates to a system and method to automate both extraction of video file duration and/or video file size information about uploaded video content and calculation of audience streaming fees based at least in part on that data. The instant innovation provides for tokenized payment exchange to permit dynamic content pricing calculable in both macro and micro payments. The instant innovation provides for a platform and method for exchanging legal tender to and from system-recognized tokens. In an embodiment, the instant innovation provides for a minimum platform fee, expressed as an integer multiple of the content duration, and a set fee, representing a content-creator-determined reserve price.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

According to industry estimates, the global video streaming market exceeds a current valuation of US$50 Billion and is growing. Some streaming platforms are highly curated, while other platforms permit content providers to upload content volitionally. Existing streaming platforms that allow users to upload and price content do not use computer code to extract duration and/or file size information from uploaded video files for the basis of platform pricing. Streaming platforms set fees to both content creators and content viewers without regard to uploaded video duration and/or file size. Consequently, streaming platforms price their services based on the highest cost-to-stream files, which are the longest and largest files. This results in higher-than-necessary prices, and fewer plays, for shorter and smaller files, undermining their market potential. It also undercuts the potential for a micropayment pricing model, the implementation of which could especially benefit those content creators with lower production costs and/or shorter duration videos.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of content upload and pricing consistent with certain embodiments of the present invention.

FIG. 2 is a view of content sales consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

“Application” refers herein to software that allows a user to perform specific tasks. Applications for desktop or laptop computers are sometimes called desktop applications, while those for mobile devices are called mobile apps. When a user opens an application, it runs inside the operating system until the user closes it.

As used herein, “Content Provider” is the party that uploads content to the platform of the instant innovation and sets the “Creator's Share.” The “Creator's Share” is the set minimum amount the Content Provider has defined for purchase of certain content. In many cases, but not necessarily all, the “Content Provider” will in fact be the content creator.

“End User” refers herein to any end-user of the application described herein who purchases uploaded content, or views of uploaded content, from Content Providers.

“Cloud” refers herein to servers that are accessed over the internet and the software and databases that run those servers. For the purposes of this document, it shall also refer to any and all computer storage or management systems that also use physical databases and manually run software or Edge computing or any future variation of data storage and transfer.

“VidaFlex Pricing” refers herein to the commercial pricing algorithm under which users are presented with the ability to purchase video products with the price determined by the method expressed herein.

In an embodiment, the instant innovation is an application that enables film and video content creators to monetize generated content in ways more efficient and effective than those in current use. Existing streaming platforms set fees for content regardless of the uploaded contents' duration and file size, essentially treating all video files as if they are commercially as viable as the longest and largest video files. This practice results in higher-than-necessary prices and fewer plays for shorter and smaller files. Put another way, current streaming platforms price their services as if all content is a big-budget Hollywood movie. Consequently, there is a need for an innovation which allows short films and other short form media content to be efficiently monetized. Many potential audience members will simply never pay $2.99 or $3.99—prices to which they're accustomed to stream a big budget movie—for a 10, 5 or 2-minute short film or short video. But if a computer algorithm were to use file duration and/or file size information to enable micropayment (below $0.99) pricing options for the streaming of short form content, those same audience members could be far more interested in sampling those videos.

In an embodiment, the instant innovation allows streaming platforms to use one or more adaptive algorithms to enable customized content pricing that is calculated as a function of the file size or content duration (in time).

In an embodiment, the instant innovation uses one or more adaptive algorithms to tailor platform-streaming-pricing to each individual video file. The resulting tailored streaming prices better reflect the actual costs associated with each file, and thereby create an efficient marketplace for small and mid-size video files to be monetized.

Modern video streaming requires that common types of video files such as, by way of non-limiting example, .mov or .mp4 files, must first be broken into individual six second video increments and compressed through a process known as transcoding. In an embodiment, the instant innovation makes use of real-world analysis of the actual costs associated with the transcoding of each individual video segment. This analysis, informed by rigorous testing and experimentation, has resulted in the development of an optimal pricing File Duration Monetization Coefficient (FDMC) and an optimal pricing File Size Monetization Coefficient (FSMC).

In an embodiment, when a Content Provider uploads a video file to a server under the control of a steaming platform, the instant innovation determines the incoming file's size and/or duration and uses application of the FDMC or FSMC, as appropriate, to the incoming file's duration and/or size to calculate an accurate cost to access, via streaming, downloading, or other access means, the video file content. The pricing algorithm creates a price for video files that are presented to users under the commercial term “VidaFlex Pricing.”

In an embodiment, the instant innovation enables determination of a profit margin and summation of the profit margin and the cost to stream. The sum of the profit margin and the cost to access is the “Platform Fee”—the fee the platform itself charges to provide content to an End User.

In an embodiment, the instant innovation uses the following algorithm, where VDIS is the video duration as measured in seconds and VFSKB is the video duration as measured in kilobytes:

Platform fee=[VDIS]*[FDMC]

or

Platform fee=[VFSKB]*[FSMC].

In an embodiment where APSSC refers to “Average per second streaming cost” and APKB SC refers to “Average per kilobyte streaming cost,”

FDMC=[APSSC]*[Platform profit margin+1]

and

FSMC=[APKBSC]*[Platform profit margin+1].

In an embodiment,

APSSC=[(Observed cost to stream file1)+(Observed cost to stream file2) . . . +(Observed cost to stream file n)]/[(Duration of file1 in seconds)+(Duration of file2 in seconds) . . . +(Duration of file n in seconds)]

and

APKBSC=[(Observed cost to stream file1)+(Observed cost to stream file2) . . . +(Observed cost to stream file n)]/[(File size of file1 in KB)+(File size of file2 in KB) . . . +(File size of file n in KB)].

In an embodiment, observed costs may be substituted with published costs in some or all APSSC and/or APKBSC calculations.

In an embodiment, the instant innovation enables the Content Provider to specify a separate Fixed Fee, which may be referred to herein as the “Creator's Share.” The instant innovation provides for summation of the Platform Fee and the Creator's Share to form the “Final Rental Cost,” and to communicate that Final Rental Cost to one or more End Users. Such communication may take the form of one or more targeted direct messages and/or the form of one or more published messages and/or lists.

In an embodiment, any one of the Platform Fee, the Creator's Share and the Final Rental Price (hereinafter referred to as the “Prices”), and/or any combination thereof, may be represented in any form of fiat, virtual, or other defined currency. In an embodiment, one or more Prices are presented in “grains,” where “grains” is the branded word for a defined proprietary platform token or value unit. By presenting the Prices of videos in grains the instant innovation enables currency to be both purchased and redeemed in larger batches such that financial transaction costs don't overwhelm profitability.

In an embodiment, the instant innovation uses computer code to extract video file duration and/or video file size information about uploaded content and calculates the Platform Fee based at least in part on that data. In addition to more fairly connecting platform prices with platform costs, this approach has the advantage of enabling micropayment pricing to consumers—a way of doing business that would be impossible with the fixed pricing strategies of existing streaming platforms.

In an embodiment, the instant innovation, referred to as “VidaFlex Pricing”, is implemented in a cloud-based environment, may use a computer algorithm to extract video file duration and file size metadata from uploaded video content at the time of video content upload. One or more pricing algorithms use the file duration and file size data as input for setting the Platform Fees for content. This innovation makes the business of pay-per-rental or pay-per-download video content streaming more efficient for both content creators and audience for video content that is smaller than the longest and largest movies. This allows smaller video content and video clips to be efficiently monetized, rather than be rented or sold as if they are all the longest and largest. The increased efficiency for the pricing of non-standard size or duration video content may increase the popularity and access to such film and video content the same way better efficiencies and lower pricing in other sectors often produce growth and opportunity.

In an embodiment, an End User of the instant innovation exchanges legal tender, such as, in a non-limiting example, US Dollars, British Pounds, or other valid currency, for a set number of Virtual Tokens (or, “Tokens” or “grains”) offered through a video streaming marketplace. The Tokens are held within an electronic account accessible by and under the control of the End User. When the End User selects particular content for consumption, the End User initiates payment to the Content Provider from the End User's account. Payments, including micropayments, are effectuated through Token transfer into an account accessible by and under the control of a Content Provider. Subject to certain restrictions, Token balances that meet or exceed a certain minimum threshold may be converted into legal tender and withdrawn by the Content Provider.

In an embodiment, the instant innovation uses customized pricing of uploaded content to permit a consumer to access content of any file size or time duration through the payment of a cost that is reflective of the content's streaming costs. Pricing may be determined for video content of any duration or size for such video content as video clips, short films, movies, and any other such video content captured and provided for consumption by interested end users. Such pricing may consist of a variable clip duration fee and/or a file size fee that is calculated in proportion to the size or time duration of a video clip or other video content, and a fixed fee, where this fixed fee is set by the Content Provider.

In an embodiment, the instant innovation utilizes tokenized pricing correlated to content duration and/or content file size. This tokenized pricing, associated to specific content, is delivered to an End User. To acquire selected video content as previously recited, the End User may elect to pay the quoted price to access offered video content.

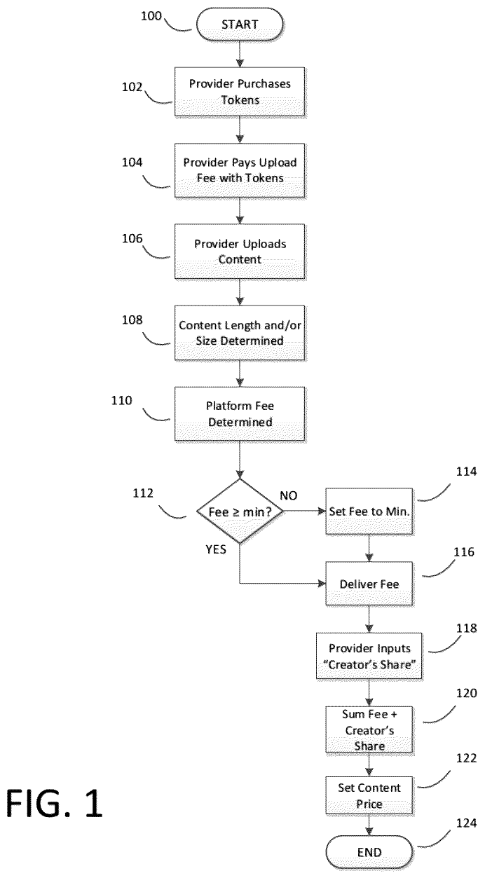

Turning now to FIG. 1, this figure presents a view of content upload and pricing consistent with certain embodiments of the present invention. At 100, the subprocess starts. At 102 the Content Provider uses legal tender to purchase Tokens though an exchange associated with the instant innovation. In an embodiment, the exchange may be Cloud-based and accessible over the Internet. At 104 the Content Provider pays a system-mandated upload fee with the purchased Tokens. Upon payment of the upload fee, at 106 the Content Provider uploads content. In an embodiment, when the uploaded content is a video file, the uploaded content is placed into a hidden HTML5<video> element and then at 108 the video length is determined by examining the video player's metadata “length” property. Errors are generated if the file is too long or of an incorrect type. At 110 the system calculates a Platform Fee by multiplying the duration of the content (by way of non-limiting example, determined in minutes) by a cost of business factor, then rounding off the result to an integer value. At 112, if the Platform Fee is greater than or equal to a minimum threshold, then at 116 the Platform Fee is delivered to the Content Provider. At 118 the Content Provider inputs the set “Creator's Share,” which in an embodiment represents the revenue per view sought by the Content Provider. At 120, the platform fee and the Creator's Share are summed to produce a Content Price at 122. At 124 the subprocess ends. If at 112 the Platform Fee does not exceed the minimum fee, then at 114 the system sets the Platform Fee to the minimum value, at 116 the Platform Fee is delivered to the Content Provider, and the subprocess continues as described above.

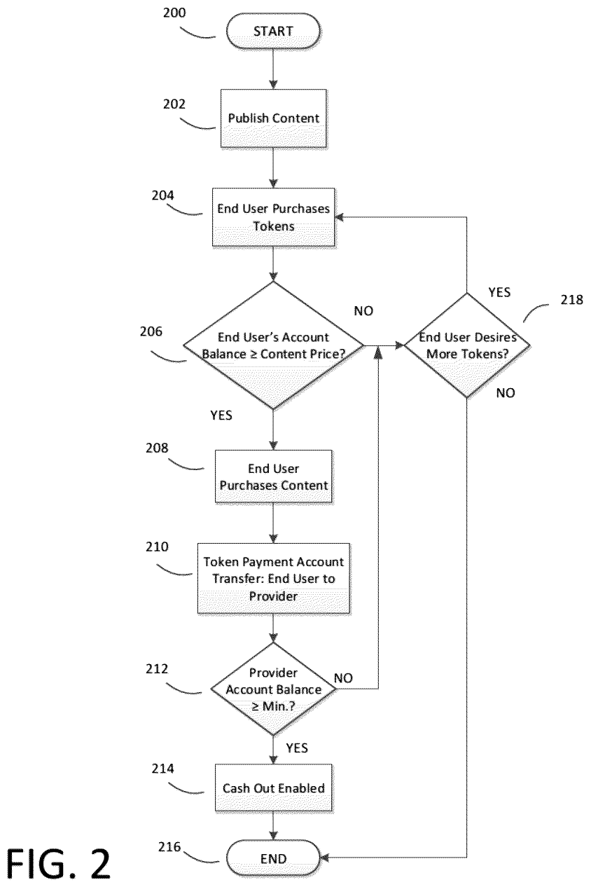

Turning now to FIG. 2, this figure presents a view of content sales consistent with certain embodiments of the present invention. At 200 the subprocess starts. At 202 content is published to the platform of the instant innovation. At 204, the End User uses legal tender to purchase Tokens. Purchased Tokens are held in a segregated account belonging to and under the control of the End User. In order to purchase content, the End User's Account Balance must equal or exceed the Content Price. If at 206 the End User's Account Balance is greater than or equal to the Content Price, then at 208 the End User purchases the content and at 210 a tokenized payment is transferred from the End User's account to an account belonging to and under the control of the Content Provider. Tokens earned and deposited into the Content Provider's account may be spent by the Content Provider to upload additional content or to purchase views of content uploaded by other Content Providers. If at 212 the Content Provider's account balance exceeds a minimum value, then at 214 the Content Provider may execute a conversion of Tokens to Legal Tender. If at 206 the End User's Account Balance is less than the Content Price, then at 218 the End User may decide to purchase additional Tokens at 204. At 216 the subprocess ends.

While certain illustrative embodiments have been described, it is evident that many alternatives, modifications, permutations and variations will become apparent to those skilled in the art in light of the foregoing description

We claim:

1. A system for individually pricing audiovisual content comprising:
a server having a processor in communication with one or more End User devices;
an End User interface;
the server operative to calculate End User fees for delivered video files;
receiving one or more uploaded video files;
extracting the video file size and/or duration from received one or more uploaded video files;
using the extracted video file size and/or duration to customize streaming fees assessed to access said individual video files;
calculating tokenized pricing for delivery of the video files to an End User device;
expressing a calculated End User price as a function of the tokenized pricing;
delivering the calculated End User price to the End User interface; and
exchanging tender in the amount of the calculated End User price for delivery of the video files.

2. The system of claim 1, where the server is cloud-based.

3. The system of claim 1, where the server uses a computer algorithm to extract video file size and/or length metadata from uploaded video content.

4. The system of claim 1, where the End User exchanges legal tender for a set number of Tokens offered through a video streaming marketplace.

5. The system of claim 4, where the Tokens are held within an electronic account accessible by and under the control of the End User.

6. The system of claim 1, where payments for video content are effectuated through Token transfer from an electronic account accessible by and under the control of the End User into an account accessible by and under the control of a Content Provider.

7. The system of claim 6, where the payments may take the form of micropayments.

8. The system of claim 6, where the Tokens so transferred may be converted into legal tender and withdrawn by the Content Provider.

9. The system of claim 1, where the End User price is a function of a customized fee that is calculated in proportion to the size and/or time duration of video content, and a fixed fee.

10. The system of claim 9, where the fixed fee is set by the Content Provider.

11. A method for individually pricing audiovisual content comprising:
establishing wired and/or wireless communication between a server having a processor and one or more End User devices;
displaying the communications upon an End User interface;
receiving one or more video files;
extracting the video file duration and/or duration from received one or more video files;
using the extracted video file size and/or duration to customize streaming fees assessed to access the individual video files;
calculating tokenized pricing for delivery of the video files to an End User device;
expressing a calculated End User price as a function of the tokenized pricing;
delivering the calculated End User price to the End User interface; and
exchanging tender in the amount of the calculated End User price for delivery of the video files.

12. The method of claim 11, where the server is cloud-based.

13. The method of claim 11, where the server uses a computer algorithm to extract video file size and/or length metadata from uploaded video content.

14. The method of claim 11, where the End User exchanges legal tender for a set number of Tokens offered through a video streaming marketplace.

15. The method of claim 14, where the Tokens are held within an electronic account accessible by and under the control of the End User.

16. The method of claim 11, where payments for video content are effectuated through Token transfer from an electronic account accessible by and under the control of the End User into an account accessible by and under the control of a Content Provider.

17. The method of claim 16, where the payments may take the form of micropayments.

18. The method of claim 16, where the Tokens so transferred may be converted into legal tender and withdrawn by the Content Provider.

19. The method of claim 11, where End User fees are a function of a customized fee that is calculated in proportion to the size and/or time duration of video content, and a fixed fee.

20. The method of claim 19, where the fixed fee is set by the Content Provider.
